(19) United States
(12) Patent Application Publication
(10) Pub. No.: US 2006/0256293 A1
(43) Pub. Date: Nov. 16, 2006

(54) Image projection system

(76) Inventors: Jack L. Lawson, Indianapolis, IN (US); Todd C. Midkiff, Noblesville, IN (US); Andrew B. Mendenhall, Mooresville, IN (US)

Correspondence Address: BARNES & THORNBURG LLP, 11 SOUTH MERIDIAN, INDIANAPOLIS, IN, 46204, US

(21) Appl. No.: 11/431,893

(22) Filed: May 10, 2006

Related U.S. Application Data
(60) Provisional application No. 60/679,888, filed on May 11, 2005.

(51) Int. Cl. G03B 21/26

(52) U.S. Cl. 353/30

(57) ABSTRACT

A projection system includes a computer, a mouse-pointer unit, and a projector coupled to the computer. The projector is configured to project a video image generated by the computer onto a surface away from the computer.

This application claims the benefit of U.S. Provisional Patent Application No. 60/679,888, filed May 11, 2006 and is hereby incorporated by reference herein

### BACKGROUND

The present disclosure relates to projection systems and particularly to portable projection systems. More particularly, the present disclosure relates to portable computerized projection systems.

### SUMMARY

According to the present disclosure, an image projection system includes a computer, a mouse-pointer unit, and a projector. The portable computer and image projection system is used to make presentations, for example, where an enlarged video image is used to enhance a speaker's oral presentation.

In illustrative embodiments, the computer includes a central processing unit having a housing, a video display unit, and a keyboard. The mouse-pointer unit allows a user remotely to perform certain computer functions. The projector allows a user to project an enlarged video image from the computer to a projection surface such as a screen or wall.

Features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description refers particularly to the accompanying figures in which:

FIG. 1 is a perspective view showing a portable computer and image projection system having a central processing unit, a computer screen, a compact disc/digital video disc player (CD/DVD), a detachable keyboard situated in a keyboard cradle formed in a housing of the central processing unit, a detachable mouse-pointer unit situated in a mouse cradle formed in the housing of the central processing unit, and an image projector in accordance with the current disclosure;

FIG. 2 is a is a perspective view of the portable computer and image projection system of FIG. 1 showing the detachable keyboard and the detachable mouse-pointer unit, detached from their respective cradles formed in the housing of the central processing unit, in a remote use position;

FIG. 3 is a is a perspective view of the portable computer and image projection system of FIG. 1 showing the detachable keyboard and the detachable mouse-pointer unit, detached from their respective cradles formed in the housing of the central processing unit, in a remote use position, and the computer screen tilted and swiveled for an oblique user's view;

FIG. 4 is a perspective view of the portable computer and image projection system of FIG. 1 showing a portion of the rear side of the central processing unit having input apertures for audio and visual connectors;

FIG. 5 is a perspective view of the portable computer and image projection system of FIG. 1 showing a portion of the rear side of the central processing unit having peripheral device connector ports;

FIG. 6 is a perspective view of the detachable mouse-pointer unit detached from its cradle formed in the housing of the central processing unit;

FIG. 7 is a plan view of the detachable mouse-pointer unit detached from its cradle formed in the housing of the central processing unit showing the push-button input devices formed in the unit;

FIG. 8 is a perspective view of the detachable mouse-pointer unit detached from its cradle formed in the housing of the central processing unit showing a laser pointer designator device formed in the detachable mouse-pointer unit;

FIG. 9 is a side elevation view of the detachable mouse-pointer unit detached from its cradle formed in the housing of the central processing unit;

FIG. 10 is a perspective view of a disc holder associated with the CD/DVD player;

FIG. 11 is a perspective view of a computer screen tilt and swivel mount portion;

FIG. 12 is a rear perspective view of the portable computer and image projection system of FIG. 1 showing the optical lens housing of the image projector, and the cradles for the detachable keyboard and the detachable mouse-pointer unit formed in the housing of the central processing unit;

FIG. 13 is a perspective view of the portable computer and image projection system of FIG. 1 showing the optical lens housing of the image projector, and the cradles for the detachable keyboard and the detachable mouse-pointer unit formed in the housing of the central processing unit;

FIG. 14 is a perspective view showing a second portable computer and image projection system including a pivotable video display unit in a closed position;

FIG. 15 is a perspective view of the portable computer and image projection system of FIG. 14 showing the pivotable video display unit in an opened position and the system projecting a video image onto a projection surface;

FIG. 16 is a perspective view of a third portable computer and image projection system showing a “tilt-and-swivel” video display unit and a “joystick” controller to allow a user to adjust a projection angle;

FIG. 17 is a perspective view of the portable computer and image projection system of FIG. 16, with portions broken away, showing the “joystick” lens angle controller;

FIG. 18 is a perspective view of a fourth portable computer and image projection system showing a pivotable carrying handle and lens cap in a transport position, the lens cap coupled to the optical lens, and the carrying handle extending across a finger-receiving recess formed in the housing;

FIG. 19 is a perspective view of the portable computer and image projection system of FIG. 18 showing the pivotable carrying handle moved to a use position where the carrying handle is configured to be used as a foot for the projection system;

FIG. 20 is a perspective view of a fifth portable computer and image projection system showing a transporter case including a shoulder strap coupled to the system, and a user shouldering the portable computer and image projection system coupled to the transporter case; and

FIG. 21 is a perspective view of the portable computer and image projection system of FIG. 20 showing the portable computer and image projection system coupled to the transporter case in a use position.

### DETAILED DESCRIPTION

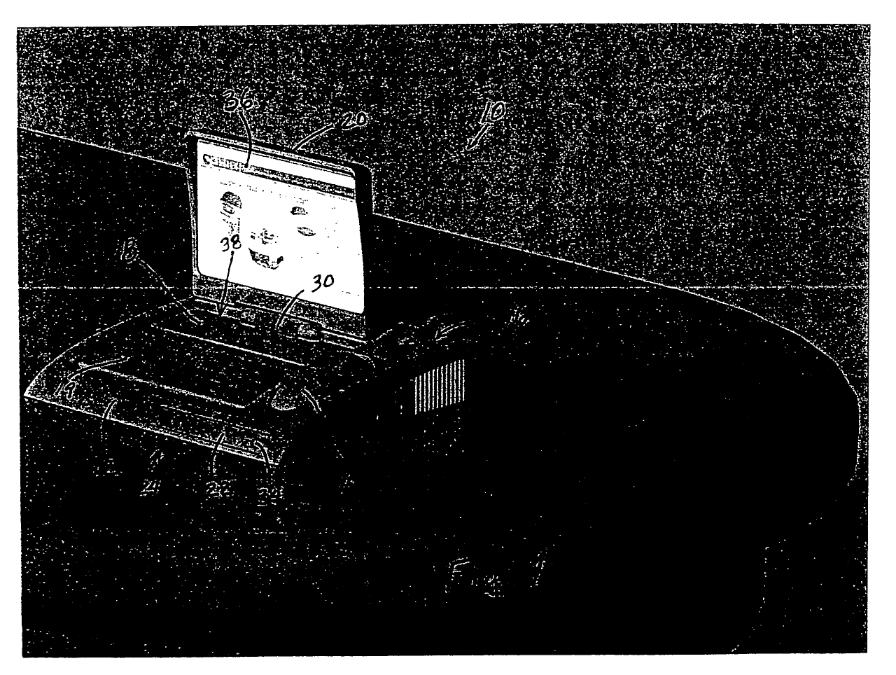

An image projection system 10 includes a computer 12, a mouse-pointer unit 14, and a projector 16 as shown, for example, in FIGS. 1-3. Computer 12 includes a central processing unit (CPU) 18, a keyboard 19, a video display unit 20, and a compact disc/digital video disc (CD/DVD) player 22.

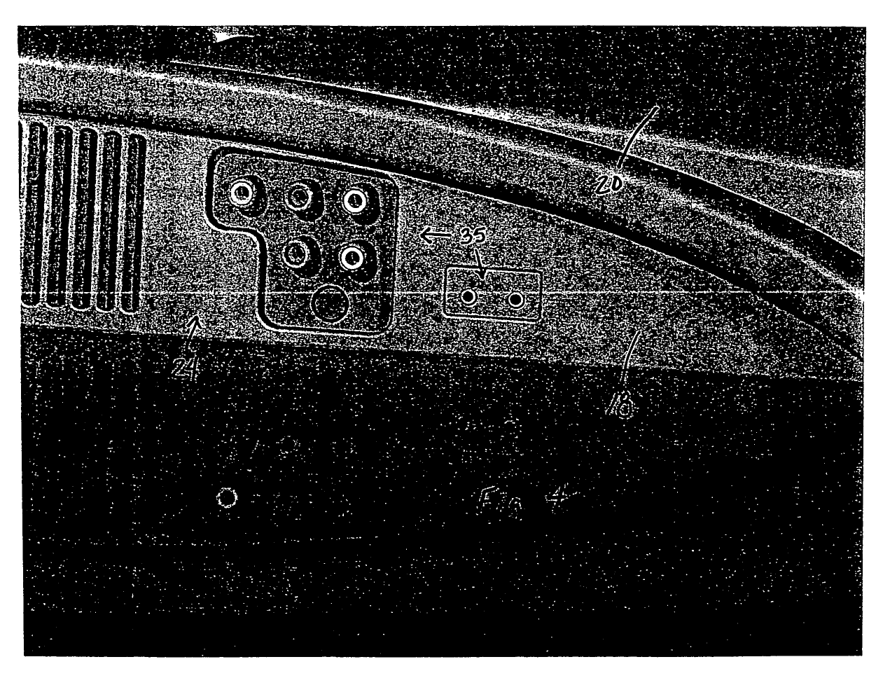

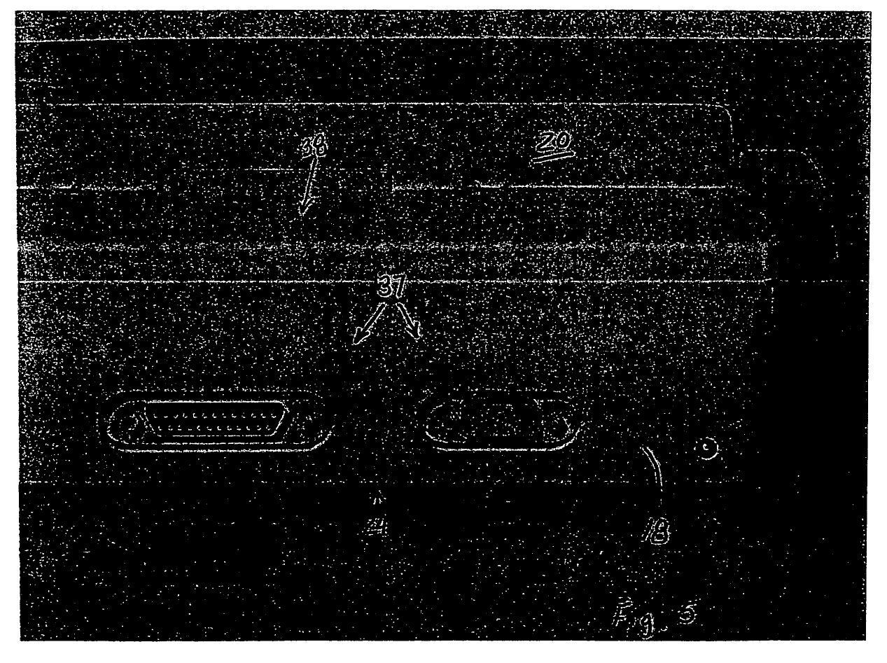

CPU 18 includes a housing 24 having an upper surface 38 formed to include a keyboard cradle 26 to hold keyboard 19, a mouse cradle 28 to hold mouse-pointer unit 14, and an aperture 32 formed in housing 24 to receive a disc retainer tray 34 therethrough for a user to insert CDs or DVDs into CD/DVD player 22 as shown in FIGS. 1-3. Referring now to FIGS. 4 and 5, CPU 18 further includes a number of audio-visual connector ports 35 and computer peripheral device connector ports 37 formed in housing 24.

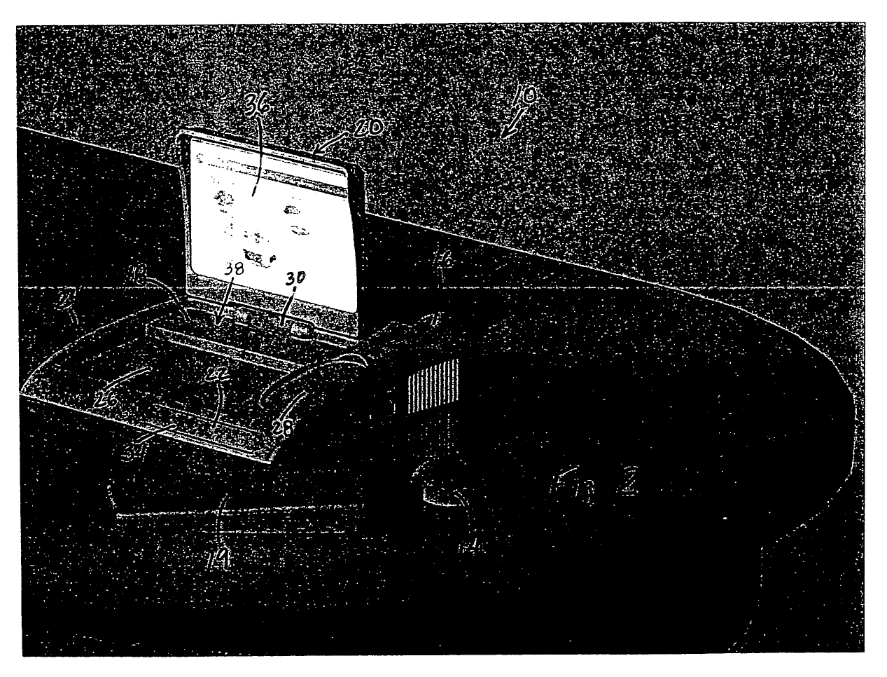

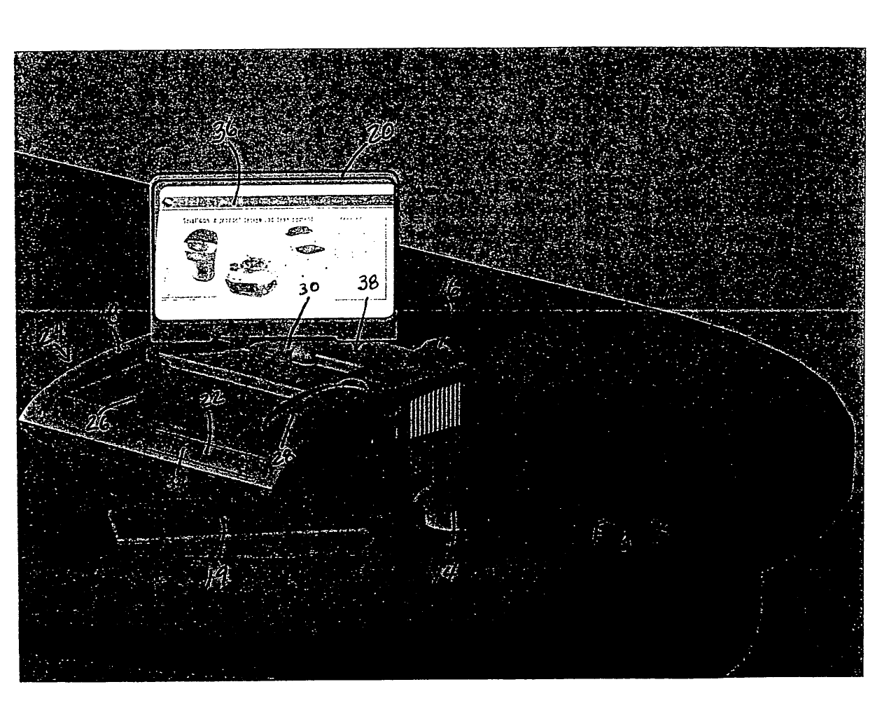

Keyboard 19 is coupled to and detachable from computer 12 and is arranged to nest in keyboard cradle 26 in a normal computer use position. Keyboard 19 is configured to be detached from computer 12 and to operate without connecting cables in a “wireless” mode of operation, as illustrated in FIGS. 2 and 3.

Video display unit 20 includes liquid crystal screen 36, and a tilt-and-swivel mount 30, as shown in FIG. 3. Tilt-and-swivel mount 30 is used to movably couple video display unit 20 to housing 24. Mount 30 allows the user to pivot screen 36 relative to housing 24 from a closed position where display unit 20 is generally coplanar to surface 38 of housing 24, to a use position where display unit 20 is arranged in a non-coplanar relation to surface 38. Tilt-and-swivel mount 30 also allows the user to rotate display unit 20 about a generally vertical axis when display 20 is opened to the non-coplanar use position.

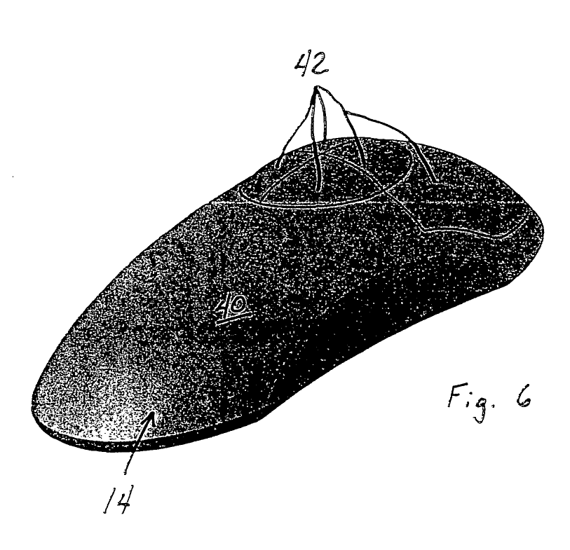

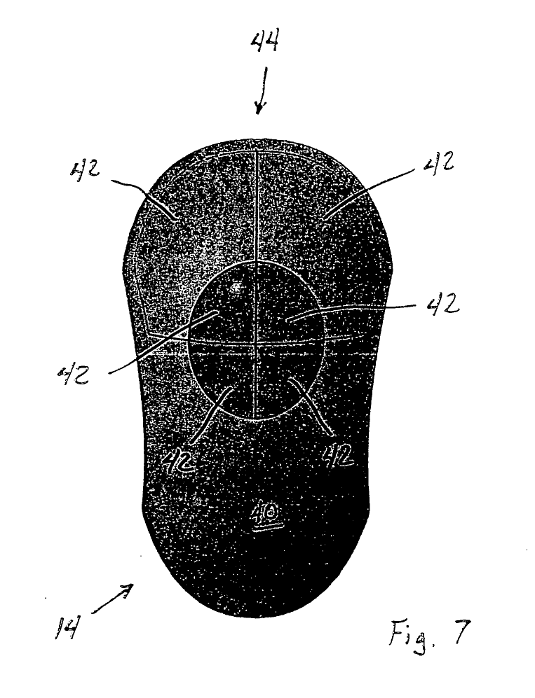

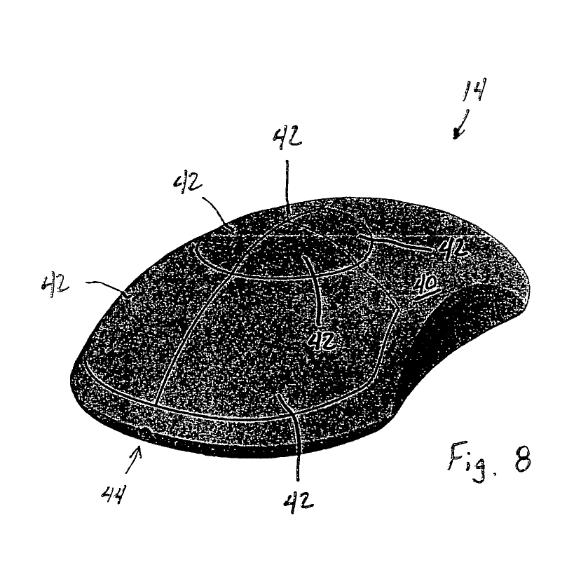

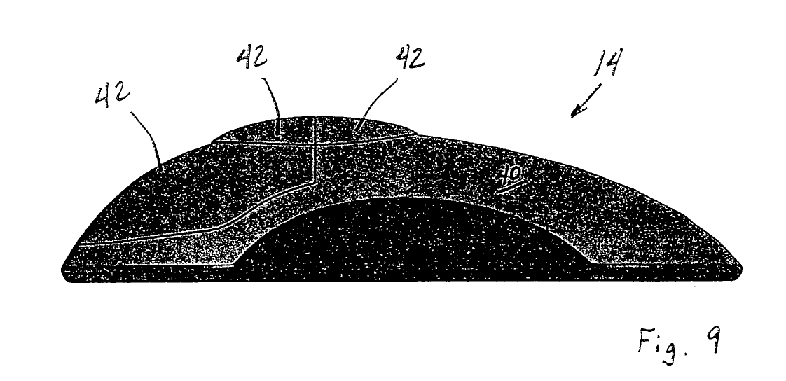

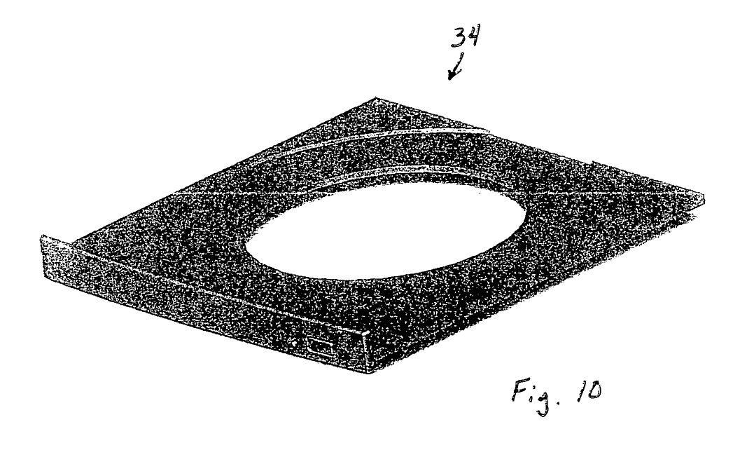

Mouse-pointer unit 14 includes a mouse 40 having a number of buttons 42 coupled to a top wall of mouse 40 that perform certain computer functions in response to buttons 42 being pressed downwardly toward mouse 40 and a laser pointer 44 formed in a forward surface of mouse 40, as shown best in FIGS. 6-9. Mouse 40 is coupled to and detachable from computer 12 and is arranged to nest in mouse cradle 28 formed in surface 38 of housing 24 in a normal computer-use position. Mouse 40 is configured to be detached from computer 12 and to operate without connecting cables in a “wireless” mode of operation. Mouse-pointer unit 14 also allows the user to highlight or designate certain portions of a projected display, for example, by using laser pointer 44 arranged in mouse 40 and activated by the user depressing one of buttons 42.

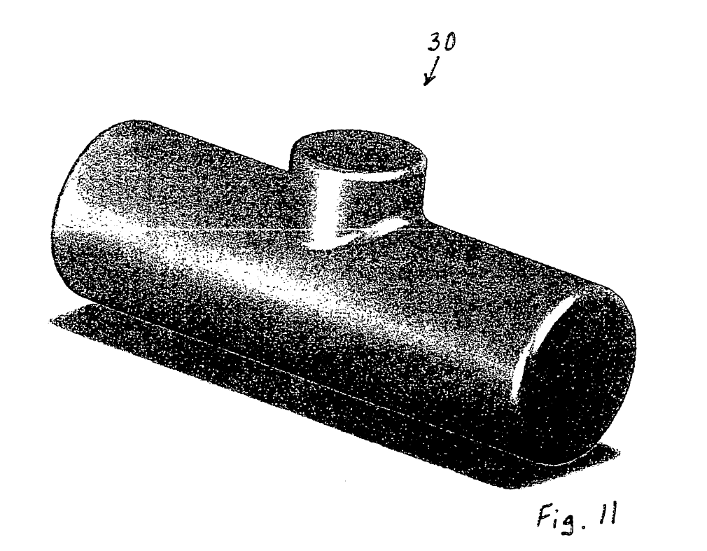

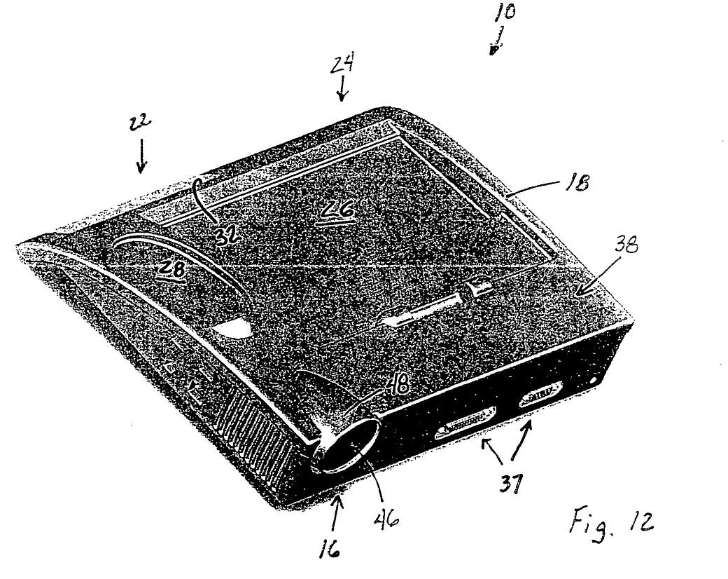

Projector 16 includes an optical lens assembly 46, a lens housing 48, and means for projecting an enlarged video image onto a nearby surface, for a presentation, for example, by a public speaker or presenter, as shown in FIG. 12. Means for projecting an enlarged video image may include an optically amplified digital display or other methods of projecting a video image to a projection screen or surface.

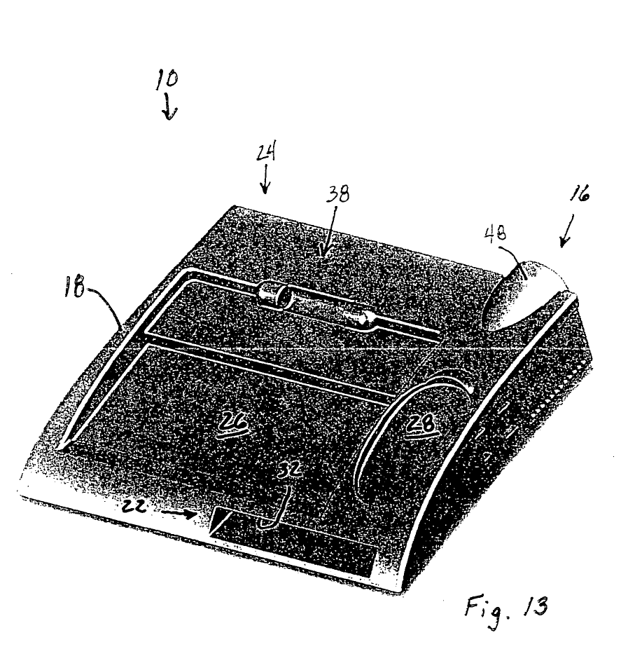

According to a second embodiment of a portable computer and image projection system 110, video display unit 120 is coupled to CPU 18 for pivotable movement of video display unit 120 relative to housing 24 from a closed position so that video display unit 120 is generally coplanar to surface 38 of housing 24, to a use position so that video display unit 120 is arranged in a non-coplanar relation to surface 38, as shown best in FIGS. 14 and 15. Portable computer and image projection system 110 includes a wireless keyboard 19. Wireless keyboard 19 may include an integrated pointer controller coupled to keyboard 19 and configured to manipulate computer-generated symbols displayed on the video display unit or projected image. Unlike the first embodiment, video display unit 120 is arranged to pivot from the closed position to the opened position, but does not swivel from side-to-side.

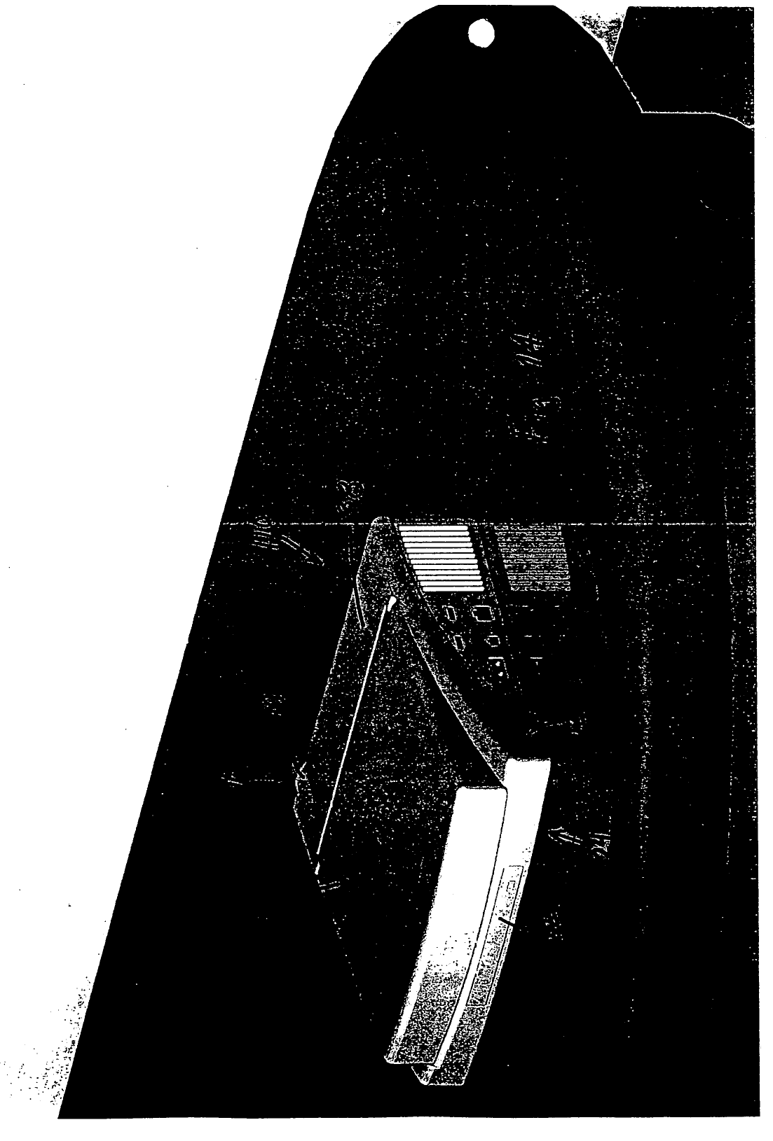

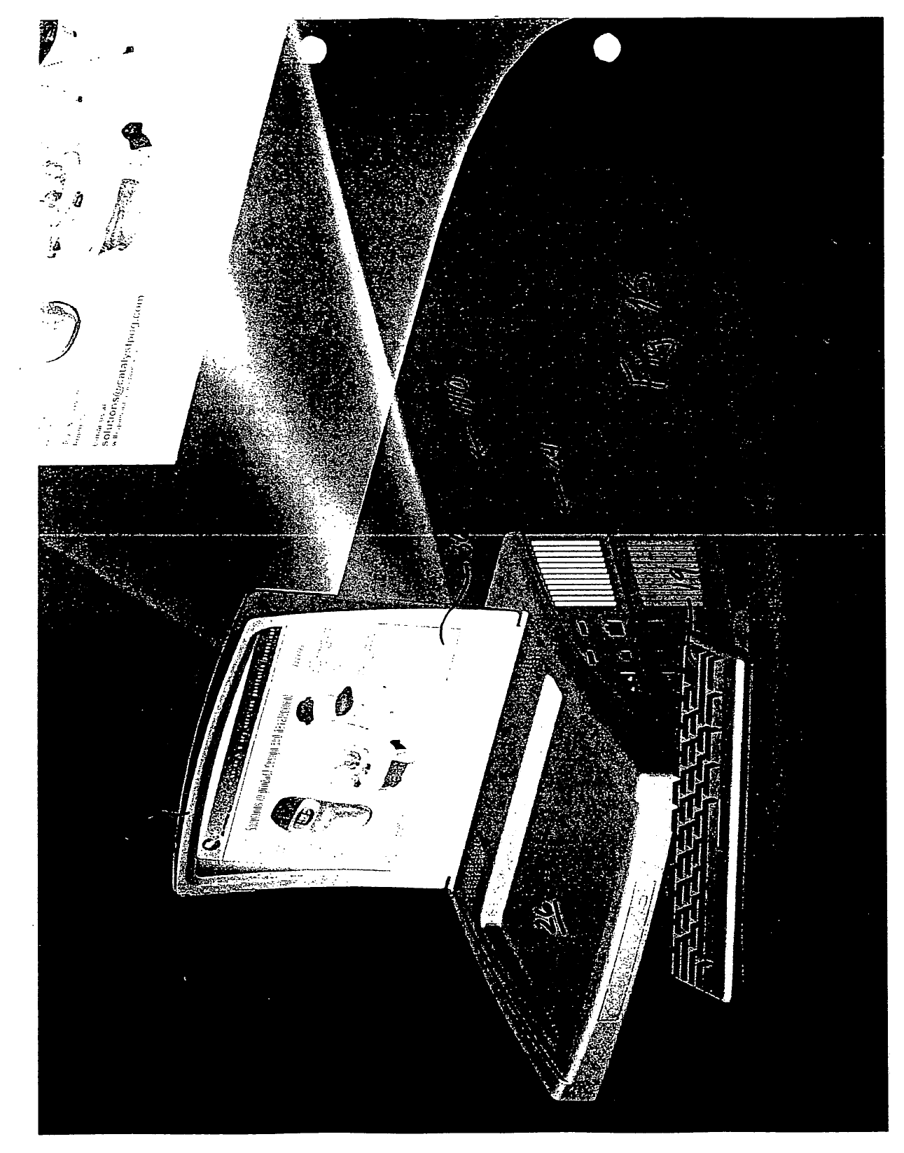

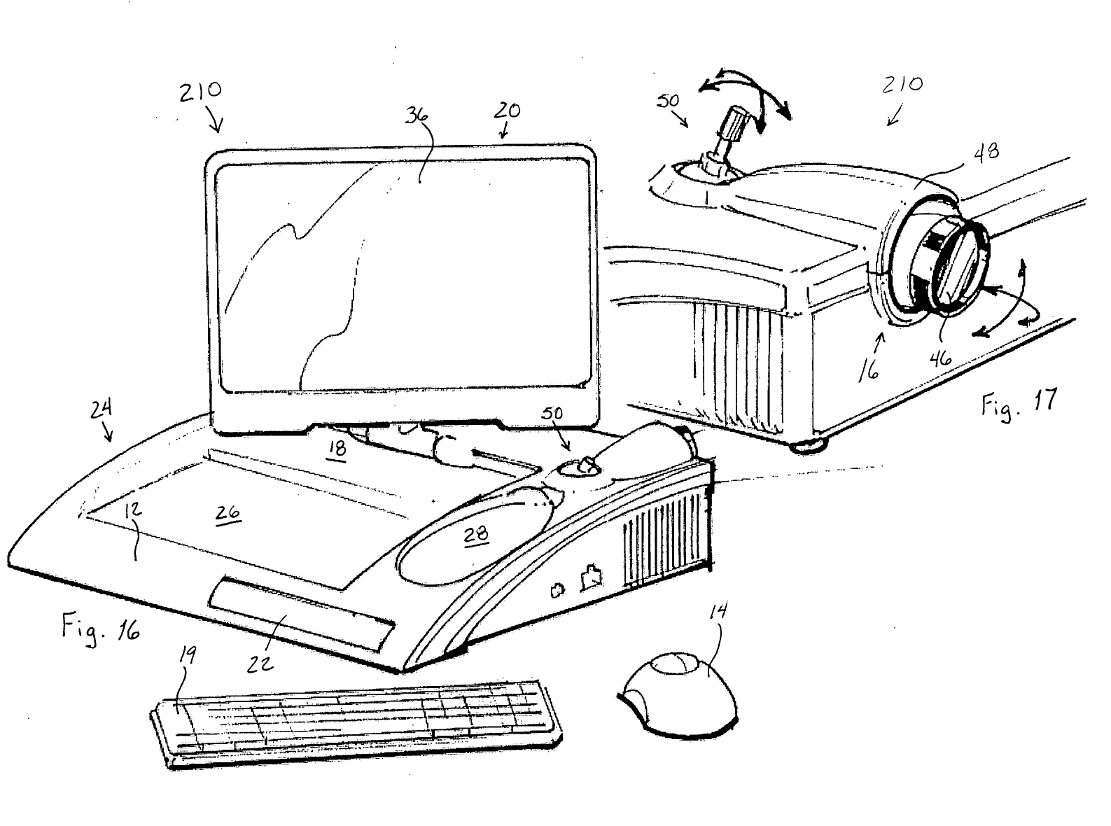

Referring now to FIGS. 16 and 17, a third embodiment of a portable computer and image projection system 210 may include foot/lens swivel means for adjusting the video projection angle so that the video image is movable in relation to the projection surface. Portable computer and image projection system 210 includes a “joystick” controller 50 coupled to an adjustable optical lens assembly 46. Controller 50 cooperates with adjustable optical lens assembly 46 to provide means for manually adjusting the video image projection angle so that, when controller 50 is moved directionally, optical lens assembly 46 moves in a corresponding direction to allow directional movement of the projected video image.

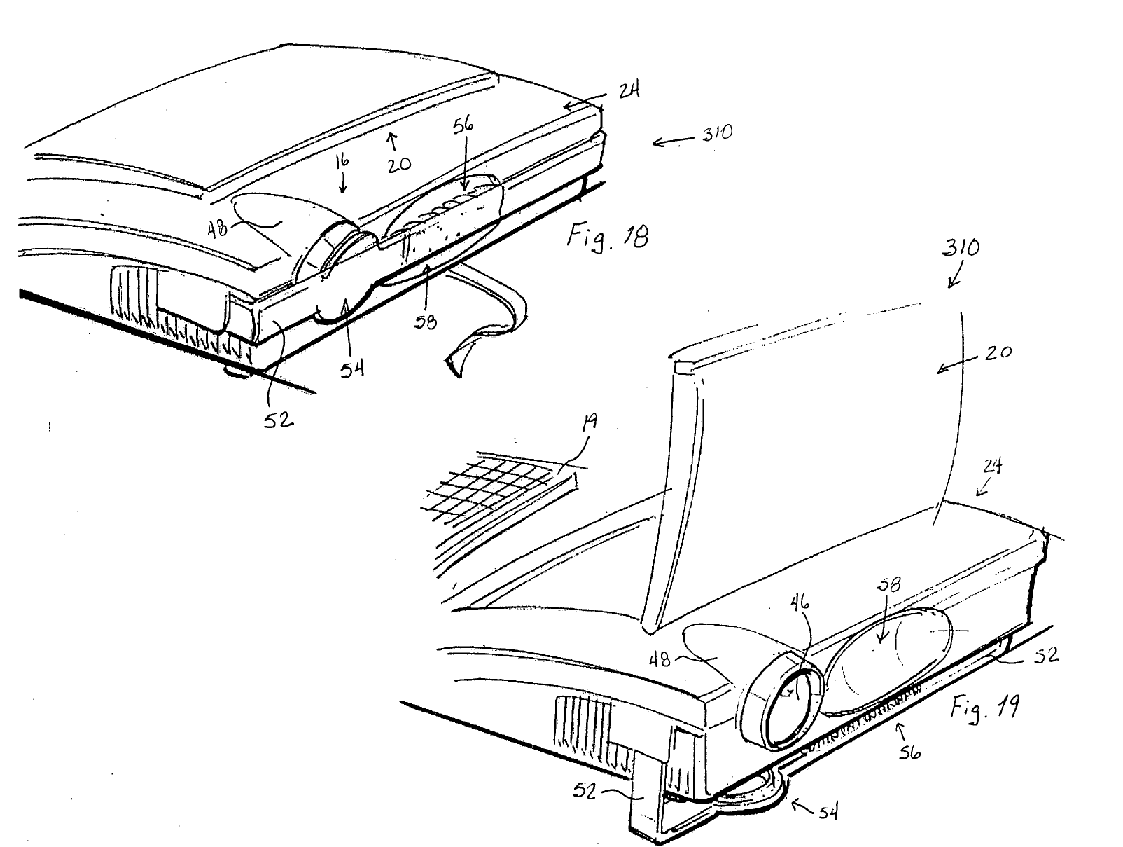

A fourth portable computer and image projection system 310 may include a carrying handle 52 having a first portion 54 and a second portion 56, as shown, for example, in FIGS. 18 and 19. Handle 52 is coupled to housing 24 for pivotable movement between a first and a second position. In the first position, handle 52 provides the user with means for transporting the projection system 310 in the closed position. Illustratively, first portion 54 of handle 52 is an annular cap configured to be received by lens housing 48 when handle 52 is in the first position. Annular cap 54 is configured to guard optical lens assembly 46 and inhibit unintended contact thereto. Second portion 56 cooperates with a finger-receiving notch 58 formed in housing 24 to form a carrying handle. Handle 52 is adapted to be moved by the user from the first position to the second position to form a support leg when projection system 210 is positioned on a support surface such as, for example, a table or podium.

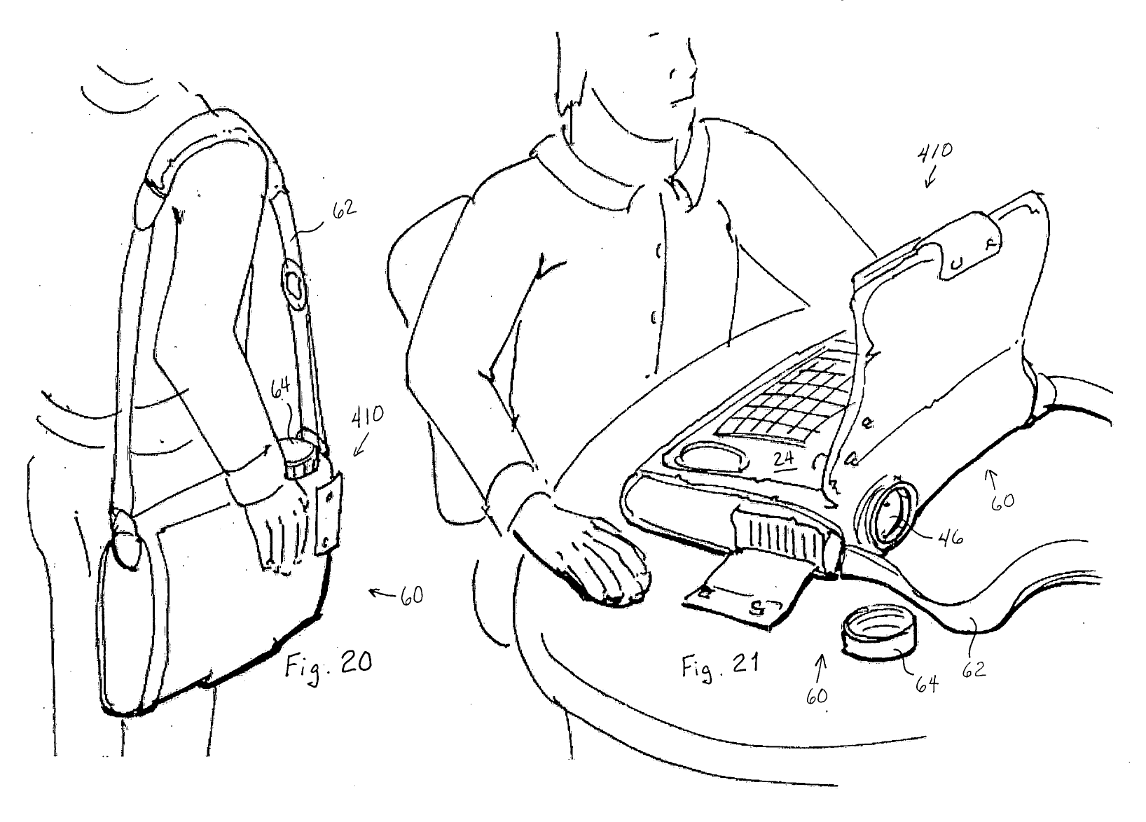

A fifth portable computer and image projection system 410 may include a transporter case 60 coupled to housing 24 as shown in FIGS. 20 and 21. Case 60 may be constructed from a variety of materials including leather, canvas, cotton ducking, or Cordura nylon. Case 60 includes a shoulder strap 62 and a lens cap 64. Case 60 is well-suited to transport projection system 410 and allows the user to operate projection system 410 without uncoupling case 60 from housing 24.

1. A projection system comprising
a computer having a central processing unit including a housing, a video display unit in communication with the central processing unit coupled to the housing, a keyboard coupled to the housing, the keyboard configured to be in communication with the central processing unit,
a mouse-pointer unit configured to be in communication with the central processing unit to transmit a signal from the mouse-pointer unit to the central processing unit, and
means for projecting a video image from the housing onto a surface spaced apart from the housing.

2. The projection system of claim 1, wherein the projection means includes an optical lens assembly and a lens housing formed in the computer housing to receive the optical lens assembly, the optical lens assembly having an optically amplified digital display to project the video image onto the surface.

3. The projection system of claim 2, further including a digital video disc player coupled to the housing and being configured to receive digital video discs to access video images stored thereon, the digital video disc player configured to be in communication with the central processing unit to generate and project video images stored on the digital video discs.

4. The projection system of claim 3, further comprising a mounting member, and wherein the video display unit is coupled to the housing through the mounting member to rotate in a first direction about a horizontal axis and to rotate in a second direction about a generally vertical axis.

5. The projection system of claim 1, wherein the mouse-pointer unit and the keyboard are configured to wirelessly communicate with the central processing unit.

6. The projection system of claim 5, wherein the mouse-pointer unit and the keyboard are removably coupled to the housing.

7. A projection system comprising
a computer having a central processing unit including a housing, a video display unit in communication with the central processing unit coupled to the housing to display video images generated by the central processing unit, and a keyboard in communication with the central processing unit,
a mouse-pointer unit coupled to the housing including a mouse and a laser pointer, the mouse-pointer being configured to be in communication with the central processing unit, and
a projector coupled to the housing such that a portion of the projector is positioned to lie within the housing, the projector having an optical lens assembly and configured to be in communication with the central processing unit to project a video image generated by the central processing unit onto a surface away from the housing.

8. The projection system of claim 7, further comprising a mounting member, and wherein the video display unit is coupled to the housing through the mounting member to rotate in a first direction about a horizontal axis and to rotate in a second direction about a generally vertical axis.

9. The projection system of claim 8, wherein the mouse-pointer unit and the keyboard are configured to wirelessly communicate with the central processing unit.

10. The projection system of claim 9, wherein the mouse-pointer unit and the keyboard are removably coupled to the housing.

11. The projection system of claim 7, wherein the mouse-pointer unit and the keyboard are detachably coupled to the housing.

12. The projection system of claim 7, further comprising a digital video disc player coupled to the housing and being configured to receive digital video discs to access video images stored thereon, the digital video disc player configured to be in communication with the central processing unit to generate and project video images stored on the digital video discs.

13. A projection system comprising
a computer having a housing, a video display unit in communication with the computer movably coupled to the housing to display video images generated by the computer, and a digital video disc player coupled to the housing to be in communication with the computer,
data input devices configured to wirelessly communicate with the computer, and
a projector coupled to the housing such that a portion of the projector is positioned to lie within the housing, the projector having an optical lens assembly and configured to be in communication with the computer to project a video image generated by the computer onto a surface spaced apart from the housing.

14. The projection system of claim 13, wherein the projector is pivotably coupled to the housing for movement of the optical lens assembly to move the projected video image.
